(19) United States
(12) Patent Application Publication
(10) Pub. No.: US 2023/0339677 A1
(43) Pub. Date: Oct. 26, 2023

(54) HIGH EFFICIENCY RECOVERY SYSTEM FOR INDUSTRIAL WASTE

(71) Applicant: YOSHITANI DOBOKU KABUSHIKIKAISHA, Chiba (JP)

(72) Inventors: Tokuichi YOSHITANI, Chiba (JP); Takuma YOSHITANI, Chiba (JP)

(21) Appl. No.: 18/332,338

(22) Filed: Jun. 9, 2023

Related U.S. Application Data
(63) Continuation of application No. PCT/JP2021/045498, filed on Dec. 10, 2021.

(30) Foreign Application Priority Data
Dec. 28, 2020 (JP) 2020-219039

(51) Int. Cl. B65F 3/00; G06V 20/56

(52) U.S. Cl. CPC B65F 3/00; G06V 20/56

(57) ABSTRACT

[Problem to be solved] To provide a high-efficiency collection system that improves working efficiency by performing reception operation more easily and promptly. [Solution] A high-efficiency collection system 1000 for industrial waste includes a vehicle-mounted unit 1210 and a controller 1120. The vehicle-mounted unit 1210 is mounted on a waste transport vehicle 1200 that collects industrial waste and transports the industrial waste to a treatment site. The controller 1120 is provided at an acceptance facility that accepts and treats the industrial waste, acquires a load weight on the waste transport vehicle 1200 measured using a weighbridge 1110, receives industrial waste treatment related information from the vehicle-mounted unit 1210, and performs acceptance operation. The industrial waste treatment related information includes at least the name of a waste generator, a transport trustee, a transport permission number, the type, quantity, shape, and packing type of the industrial waste to be discharged, a driver's name, and a transport date.

### CROSS-REFERENCE TO RELATED APPLICATIONS

This application is a continuation under 35 U.S.C. §120 of International Application No. PCT/JP2021/045498, filed Dec. 10, 2021, which claims priority to Japanese Patent Application No. JP2020-219039, filed Dec. 28, 2020, under 35 U.S.C. §119(a) now Japanese Patent JP6892720B1. Each of the above-referenced patent applications is incorporated by reference in its entirety.

### BACKGROUND OF THE INVENTION

### Field of the Invention

The present invention relates to a high-efficiency collection system for industrial waste.

### Description of the Related Technology

During conventional disposal of industrial waste, it is required to take a procedure such as billing based on a measured rate system according to the weight of the waste. This necessitates measurement using a truck scale or a weighbridge and at the same time, necessitates implementations of reception operation, issuance of forms, issuance of a manifest (industrial waste management form), etc. Hence, a substantial amount of time is required and a long line of a traffic jam waiting for reception is causes this system to take a huge amount of time.

Industrial waste generated at factories, worksites, etc. is loaded on a dump truck, for example, permitted to be used for collection/transport, carried into an acceptance facility permitted for a treatment item, and subjected to intermediate treatment and final disposal. In this case, while the acceptance facility measures the weight of the carried-in industrial waste using a measuring weighbridge (such as a truck scale) installed in an acceptance operation facility and accepts the industrial waste, it takes time to settle a manifest submitted to the facility from a transporter (driver). As a result, a jam of following transport vehicles causes a waiting time. This causes a long line of vehicles and it is not uncommon for the vehicles to stay on a road around the facility waiting for their turns.

Such a jam imposes environmental load due to exhaust gas from the waiting vehicles. Furthermore, a long line of the waiting vehicles also causes a traffic jam on the road around the facility. Additionally, if carrying-in is conducted several times, the waiting time on the vehicle generated on each occasion causes a longer cycle time for waste collection during there-and-back movements (time required for collection in a day). This leads to considerable increase in transport cost, resulting in a situation where burden of expense on an end user remains high.

Additionally, while social-distance equipment is installed on a reception side of the acceptance facility, physical transfer of a document such as that made of paper is made. This causes a risk of promoting infection spread due to adhesion of disease germs or viruses.

For example, Patent Literature 1 describes the following. For the purpose of “providing a waste weight management system capable of encouraging reduction in installation cost for a truck scale or capable of encouraging elimination of a jam of vehicles due to waiting for weighing using the truck scale by allowing the weight of waste discharged from a waste treatment site to be managed without implementation of a measuring work using the truck scale,” according to a configuration described herein, “a waste collection vehicle 3 includes: a memory 21 storing weight data about collected waste obtained by measurement using measuring means (26, 27); and a radio transmitter 23 and an antenna 25 that transmit the weight data by radio stored in the memory 21, and a waste treatment site 8 includes: an antenna 45 and a radio receiver 44 that receive the weight data transmitted by radio from the waste collection vehicle 3; and a computer 4 for management that manages the received weight data.”

### Prior Art Literatures

### Patent Literatures

Patent Literature 1: Japanese Patent Application Publication No. 2009-211346

Patent Literature 2: Japanese Patent Application Publication No. 2014-186527

Patent Literature 3: Japanese Patent Application Publication No. 2004-231387

Patent Literature 4: Japanese Patent Application Publication No. 2019-164574

### SUMMARY

### Problem to be Solved by Invention

The present invention has been made in view of the conventional problems occurring during measurement and reception for treatment of waste, and is intended to suggest a collection system that improves working efficiency by performing reception operation more easily and promptly. Preferably, the present invention is also intended to reduce environmental load and furthermore, to encourage prevention of spread of disease infection by adopting noncontact handling.

### Solution to Problem

A high-efficiency collection system for industrial waste according to the present invention comprises: a vehicle-mounted unit mounted on a transport vehicle that collects industrial waste and transports the industrial waste to a treatment site; and a controller provided at an acceptance facility that accepts and treats the industrial waste. The controller acquires a load weight on the transport vehicle measured using a weighbridge, receives industrial waste treatment related information from the vehicle-mounted unit, and performs acceptance operation. The industrial waste treatment related information includes at least the name of a waste generator, a transport trustee, a transport permission number, the type, quantity, shape, and packing type of the industrial waste to be discharged, a driver's name, and a transport date.

Preferably, the high-efficiency collection system for industrial waste according to the present invention is characterized in that the controller includes: a camera that acquires a video picture of an outer appearance of the transport vehicle; and AI that estimates the type and weight of a load on the transport vehicle on the basis of the video picture acquired by the camera, conformity between the weight of the load estimated by the AI and the load weight on the transport vehicle measured using the weighbridge is determined, and the load weight is printed on a manifest and the manifest is output if the presence of the conformity is determined.

More preferably, the high-efficiency collection system for industrial waste according to the present invention is characterized in that the controller determines conformity of the load type on the transport vehicle estimated by the AI with a load type written on the manifest submitted by the driver and read by a scanner or/and with a load type included in the industrial waste treatment related information received from the vehicle-mounted unit, and prints an approval stamp for the load type on the manifest and outputs the manifest if the presence of the conformity is determined.

More preferably, the high-efficiency collection system for industrial waste according to the present invention is characterized in that the industrial waste treatment related information further includes a contract No. based on an industrial waste treatment contract document.

More preferably, the high-efficiency collection system for industrial waste according to the present invention is characterized in that the shape of the industrial waste is distinguished at least between solid, muddy, and liquid, and the packing type of the industrial waste is distinguished at least between loose, in a container, in a drum, or in a bag.

More preferably, the high-efficiency collection system for industrial waste according to the present invention is characterized in that a printer provided to the controller has a print format for a manifest or/and a print format for a waste material acceptance form.

### Advantageous Effects of Invention

It is possible to suggest a collection system that improves working efficiency by performing reception operation more easily and promptly. More preferably, it is possible to reduce environmental load and furthermore, to encourage prevention of spread of disease infection by adopting noncontact handling.

### BRIEF DESCRIPTION OF THE DRAWINGS

FIG. 1 is a view explaining a manifest type.

FIG. 2 is a view explaining a typical example of running of an electronic manifest.

FIG. 3(a) is a view explaining a typical example of a high-efficiency collection system for industrial waste according to the present invention, and FIG. 3(b) is a view showing a relationship between a vehicle-mounted unit and a controller in an acceptance building.

FIG. 4 is a view showing a model sample of a manifest.

FIG. 5 is a view showing a model sample of a waste material acceptance form.

### DETAILED DESCRIPTION

### Embodiments for Carrying Out Invention

The present system is to improve working efficiency at an industrial waste acceptance facility and an industrial waste transport vehicle, and preferably, to reduce environmental load, and take action for prevention of spread of disease infection by adopting noncontact handling.

Preferably, a vehicle-mounted unit mounted on a vehicle stores information on an industrial waste generator, the specification and vehicle No. of a transport vehicle, and driver information registered with the vehicle-mounted unit, and an acceptance operation facility performs measurement using a weighbridge and at the same time, performs information processing by transmitting information data to reception side by radio from the vehicle-mounted unit. By doing so, reception operation is completed entirely while the driver remains on the vehicle. This shortens reception time and furthermore, simplifies work relating to the reception operation, thus improving operation effectiveness.

Shortening the reception time causes a relaxation of a traffic jam caused by following waiting vehicles. Shortening of cycle time of waste collection is also realized, leading to cost reduction in transport cost. Effects are also achieved in terms of reducing exhaust gas from the vehicles in the jam, and preventing infection with disease germs resulting from improvement to a noncontact style not involving physical contact through paper, for example. In other words, preferable advantages may include shortening of operation time of accepting trash or waste, relaxation of a jam caused by waiting for order of measurement, reduction in environmental load imposed by exhaust gas to be achieved by the relaxation of the jam, reduction in work load resulting from automation of counting operation, increased speed of work at a waste transport and treatment site resulting from improved transport efficiency, elimination of shortage of transports vehicle in a busy period (improvement of efficiency in running transport vehicles), and increased speed and simplification of writing work on a manifest.

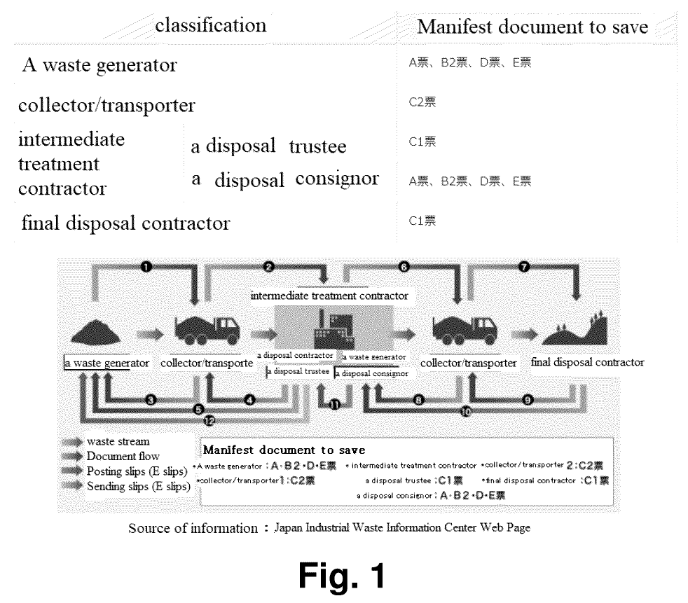

FIG. 1 is a view explaining a manifest type. A format for a paper manifest is defined under Article 8-21, Item 2 of Japanese enforcement regulations. A manifest is a multipart form with six sheets including A, B1, B2, C1, C2, D, and E. Each of the forms has the following meaning.

The form A (a duplicate from a waste generator) is a document from a waste generator (in the building industry, a general contractor). The form B1 (a duplicate from a transport company 1) is a document for verifying that transport to a disposal site was done by a transport company under contract with the waste generator (a transport trustee 1 written on the manifest). The form B2 (a duplicate from the waste generator) is a document for notifying that the transport was made to the disposal site by the transport company. The form C1 (a duplicate from the disposal site) is a document for verifying that the disposal site made acceptance. The form C2 (a duplicate from the transport company 1) is a document for notifying that the acceptance was made from a disposal company to the transport company. The form E (received by the waste generator) is a document for verifying that the disposal has been completed and notifying the completion to the waste generator. The form F (received by the waste generator) is a document for verifying that the disposal has been completed and notifying the completion to the waste generator.

After industrial waste discharged from the waste generator is collected, the waste is transported and carried to the disposal site by the transport vehicle. After the collection/transport vehicle arrives at the disposal site, a total weight including the vehicle and a load on the vehicle is measured using a measuring weighbridge, and a remaining weight determined by subtracting the weight of the vehicle from the total weight is treated as the weight of the load on the vehicle. A driver of the vehicle after being subject to the measurement using the measuring weighbridge submits an industrial waste management form manifest at a reception of the disposal site, receives a reception stamp indicating approval of acceptance of the waste and at the same time, receives an acceptance form for the waste. These operations take at least about five minutes for one vehicle. Hence, if only one weighbridge is working, only 12 transport vehicles at most can be received in an hour.

After the reception, the driver receives the manifest and a waste material acceptance form for verifying the measurement. Then, the driver unloads the load to a recycling treatment site, thereby completing the disposal. Assuming that operation time required for one transport vehicle to finish measurement using the measuring weighbridge and the reception is five minutes, it takes from 50 minutes to one hour for handling receptions of 10 transport vehicles. Hence, as many as several tens of transport vehicles are lined in front of the treatment site, causing a jam making the vehicles wait for several hours.

By constructing the present system, measurement using a weighbridge, and acceptance of a manifest and handling of a measurement form for a waste material are performed simultaneously and collectively. By doing so, while about five minutes have been necessary as operation time for acceptance operation on one vehicle, this time is shortened to be equal to or less than about 1 minute. This is expected to achieve the effects of simplifying acceptance operation resulting from increased efficiency in each work, improving efficiency or frequency of transport, and alleviating a jam around a treatment site. Furthermore, by linking to data on an electronic manifest, it becomes possible to contribute to improvement of a spread of manifest electronification recommended by Japan Industrial Waste Information Center.

A PDA, a smartphone, or a dedicated unit mounted on a vehicle stores an industrial waste treatment contract document, contract information, a contract No., etc. between a waste generator and a disposal site, more specifically, some or all of items listed in Table 1 below that are inputted in advance.

TABLE 1

| a. | Waste generator Name | | |
|---|---|---|---|
| b. | Transport trustee Name, Transport permission No., Owned truck No., Driver's information | | |
| c. | Type of industrial waste | | |
| | Stabilized type | 01 | Concrete debris |
| | | 02 | Asphalt concrete debris |
| | | 03 | Other types of debris |
| | | 04 | Waste from glass/ceramic ware |
| | | 05 | Waste plastics |
| | | 06 | Waste metal |
| | | 07 | Mixture (only belonging to stabilized type) |
| | | 08 | Asbestos-containing industrial waste |
| | Controlled type | 11 | Construction sludge |
| | | 12 | Paper waste |
| | | 13 | Wood waste |
| | | 14 | Fiber waste |
| | | 15 | Waste plasterboard |
| | | 16 | Mixture (including controlled type) |
| | Specially-controlled | 21 | Waste asbestos |

| | |
|---|---|
| industrial waste | |
| Not belonging to | PCB |
| items on manifest | Food waste |

Alkaline/acid wastewater
Oils and fats
Heavy metal
Trees
Medical waste (from hospitals or welfare facilities)
Others

| | |
|---|---|
| d. | Quantity of waste |
| e. | Shape of waste Check whether solid, muddy, or liquid |
| f. | Packing type of waste Check whether loose, in container, in drum, or in bag |
| g. | Check location and name of (intended) place of final disposal site |

1. As written on consignment contract document 2. As written in this section (normally 1)

| | |
|---|---|
| h. | Transport trustee (Collector/transporter (1)) ((Collector/transporter (2)) |
| i. | Business operator as destination of transport ( treatment facility of disposal contractor) |
| j. | Disposal trustee (disposal contractor) |
| k. | Transship storage location |
| l. | Transport trustee (1) Written content Names of transport company and driver Date of transport |
| | ※ Field for driver's signature |
| | Transport trustee (2) Written content Names of transport company and driver Date of transport |
| | ※ Field for driver's signature |

Regarding courses of action to be taken on an acceptance side (waste disposal site) for industrial waste, the items on the manifest and the actual waste are compared and checked, and then approval for acceptance is made by following “2-1” to “2-3” shown in Table 2 given below using a computer or a PDA (personal digital assistant: personal information terminal).

TABLE 2
2-1. A person in charge of acceptance determines whether the type and specification of a vehicle being measured,
and the type, shape, packing type, and mass of waste conform to information in a vehicle-mounted unit in parallel
with AI, and verifies the following information.
m. Take charge of disposal (received) ※Impress of reception stamp by disposal site
n. Take charge of disposal (disposed) ※Impress of reception stamp by disposal site
o. Date of completion of final disposal (landfill disposal, reclamation, for example)
※Impress of reception stamp by disposal site
2-2. Judgment operation by AI
The AI assists the person in charge of acceptance by judging vehicle information (specification of vehicle type,
vehicle body weight, vehicle body dimension) and the type and mass of the waste.
2-3. Printing of waste material acceptance form, work of printing on manifest, and printout
When the information in the vehicle-mounted unit is approved for reception at the disposal site, the driver
receives a waste material acceptance form (statement relating to billing) and a manifest (legally obliged to be
managed for five years) printed by a printer outside an acceptance facility, unloads a load to a waste collection site,
and completes the disposal.

The following provides supplementary explanation about the function of the printer for printing the manifest shown in 2-3 in Table 2. This printer stores manifest sheets and waste material acceptance forms set on or provided in advance within the printer. Acceptance information is printed on a new sheet in response to each operation. Reception information on the acceptance side is written on the manifest with six sheets having approval stamp fields on a plurality of sheets. Thus, the manifest is configured to be issued to the driver after an approval stamp is printed on each of the pages B1, B2, C1, C2, D, and E on manifest sheets.

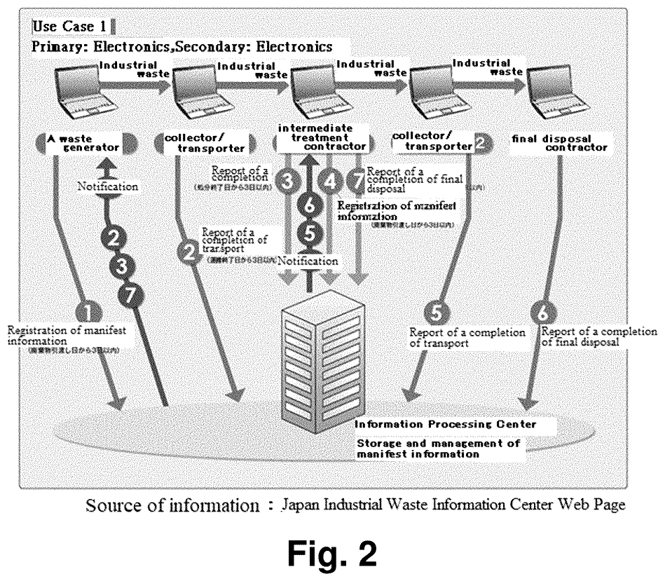

FIG. 2 is a view explaining a typical example of the operation of an electronic manifest. The operation will be described next in order based on the writing in FIG. 2 and the statement on the homepage of Japan Industrial Waste Information Center (in the following explanation, numerals in circles in FIG. 2 correspond to numerals in parentheses).

1) Registration of manifest information <from waste generator to information processing center>

A waste generator inputs necessary information using a computer to register manifest information with an information processing center within three days of transferring industrial waste to a collector/transporter or a disposal contractor (registration of (1)).

2) Report of a completion of transport <from collector/transporter to information processing center>

In response to the manifest information registered through (1), the collector/transporter submits a report of a completion of transport to the information processing center within three days of completing the transport (report of (2)).

3) Report of a completion of intermediate treatment <from intermediate treatment contractor to information processing center>

In response to the manifest information registered through (1), an intermediate treatment contractor submits a report of a completion of disposal (intermediate treatment) to the information processing center within three days of completing the intermediate treatment (report of (3)).

4) Notification of a report of completion of transport/report of completion of disposal (intermediate treatment) <from information processing center to waste generator>

Upon receiving the report of completion of the transport or the report of the disposal (intermediate treatment), the information processing center submits a notification of completion of the transport or disposal (intermediate treatment) to the computer of the waste generator (notification of (2)/(3)).

5) Secondary registration of manifest information <from intermediate treatment contractor to information processing center>

The intermediate treatment contractor registers manifest information based on each type and each destination (place of disposal contractor) of the industrial waste within three days of transferring the waste (registration of (4)).

6) Report of a completion of transport of waste after intermediate treatment (from collector/transporter 2 to information processing center)

A collector/transporter 2 submits a report of completion of transport to the information processing center within three days of completing the transport (report of (5)).

7) Report of a completion of final disposal of waste after intermediate treatment <from final disposal contractor to information processing center>

A final disposal contractor submits a report indicating completion of final disposal to the information processing center within three days of completing the final disposal (report of (6)).

8) Notification of a report of completion of transport/report of completion of final disposal <from information processing center to intermediate treatment contractor>

Upon receiving the report of completion of the transport or the report of completion of the final disposal, the information processing center submits a notification indicating completion of the transport or final disposal to a computer of the intermediate treatment contractor (notification of (5)/(6)).

9) Report of a completion of final disposal from intermediate treatment contractor <from intermediate treatment contractor to information processing center>

In response to the manifest information registered through (1), the intermediate treatment contractor submits a report of completion of the final disposal to the information processing center within three days of receiving the report of completion of the final disposal of (6) (report of (7)).

10) Report of a completion of final disposal to waste generator <from to waste generator>

Upon receiving the report of completion of the final disposal from the intermediate treatment contractor, the information processing center submits a notification indicating completion of the final disposal to the computer of the waste generator (notification of (7)).

Preferably, the present invention is linked in a manner described below to the existing electronic manifest described above constructed from the viewpoint of retaining and managing manifest information. While the above-described electronic manifest system developed by Japan Industrial Waste Information Center is intended to increase efficiency in operation by allowing a human to input operation information by hand using a computer or a smartphone for the purpose of compiling a database from a paper-based manifest, it fails to provide efficiency in acceptance operation involving measurement and reception. In view of this, the system of the present invention is incorporated as an add-in to software or an application of the electronic manifest system or is used to improve the system of Japan Industrial Waste Information Center, thereby modifying the configuration so as to omit a printout step of printing a manifest.

A spread of the electronic manifest has reached 63% in 2019 from when running of the manifest started in 2010. However, a breakdown thereof is such that, while medical and welfare facilities occupy 48.6% and retail business occupies 30.4%, the construction industry actually occupies a low percentage of 5.6%. For this reason, the system of the present invention is more preferably intended to promote running of the electronic manifest in the construction industry.

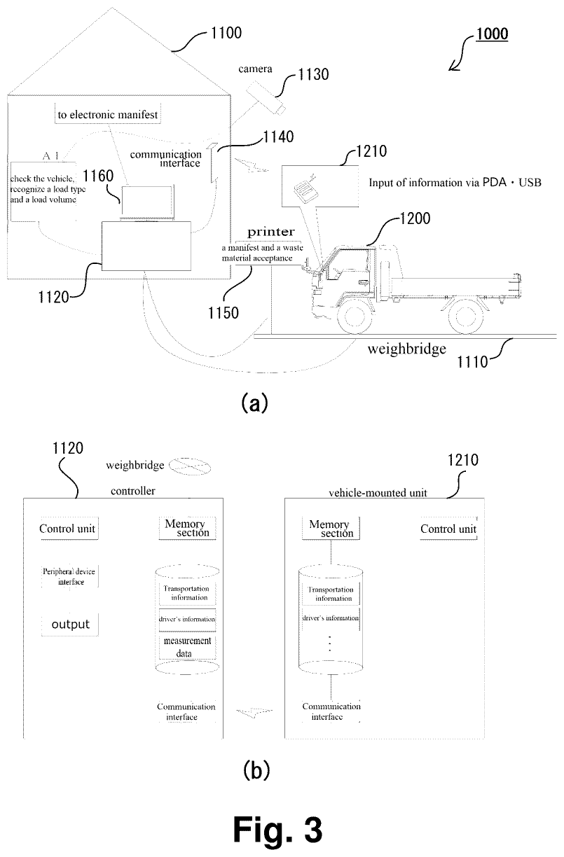

FIG. 3(a) is a view explaining a typical example of a high-efficiency collection system 1000 for industrial waste according to the present invention. FIG. 3(b) is a view showing a relationship between a vehicle-mounted unit 1210 and a controller 1120 in an acceptance building.

In FIG. 3, a waste transport vehicle 1200 having arrived at an industrial waste treatment facility is subjected to measurement using a weighbridge 1110 in the facility 1000 and check of a load and check of the vehicle using a camera 1130. Specifically, a weight value measured using the weighbridge 1110 is input to the controller 1120. An image captured by the camera 1130 is input to the controller 1120 to check the vehicle and recognize a load type and a load volume (the amount of the load). Based on the load volume acquired by the camera 1130 and the measured value acquired from the weighbridge 1110, the type and amount of the industrial waste can be estimated roughly. In this case, the controller 1120 may make the estimation or/and identification using artificial intelligence (AI) or a database.

The vehicle, the load type, and the load volume (or/and weight) checked by the controller 1120 are displayed on a display monitor 1160 and notified to the vehicle-mounted unit 1210 through a communication interface 1140. The vehicle, the load type, and the load volume are also printed out on a manifest and a waste material acceptance form using a printer 1150.

The vehicle-mounted unit 1210 may be a PDA, a smartphone, or a dedicated unit, and provides transport vehicle data (vehicle type, vehicle weight, etc.), driver's information, a waste generator of the waste, and information about a transport company stored in advance in a body of the vehicle-mounted unit 1210 or a storage medium such as a USB to a destination of acceptance through the communication interface.

On an acceptance side, the above-described information acquired from the vehicle-mounted unit 1210 through the communication interface and the measurement data from the weighbridge are analyzed by the controller 1120 such as a computer to compile a database containing the accepted vehicle information and weight of the load. Then, an item to be written on the manifest is extracted from the database and is printed out automatically. Furthermore, an acceptance form to be provided to a driver is printed and issued.

The controller 1120 feeds the above-described data in the database back through the communication interface 1140 to the body of the vehicle-mounted unit 1210 or the storage medium such as a USB connected to the vehicle-mounted unit 1210. In this case, the controller 1120 can generate a database using application software newly developed and installed in advance.

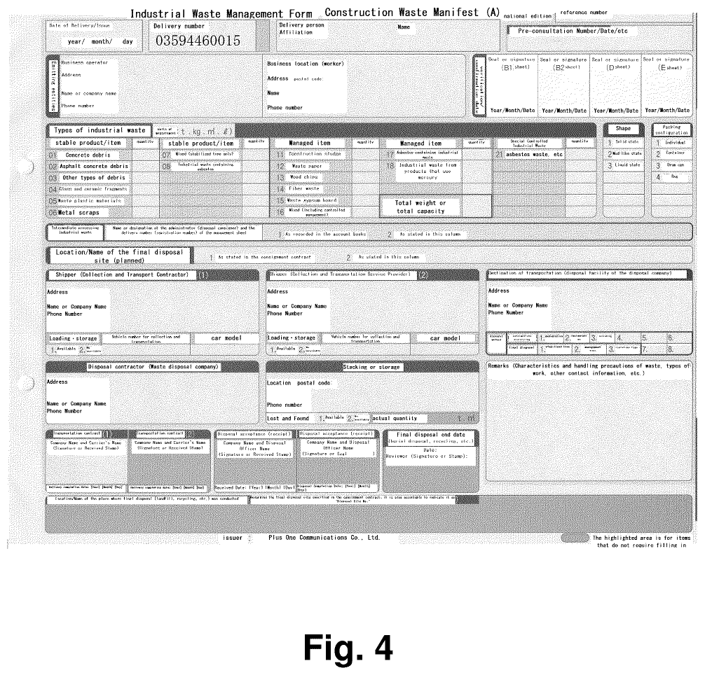

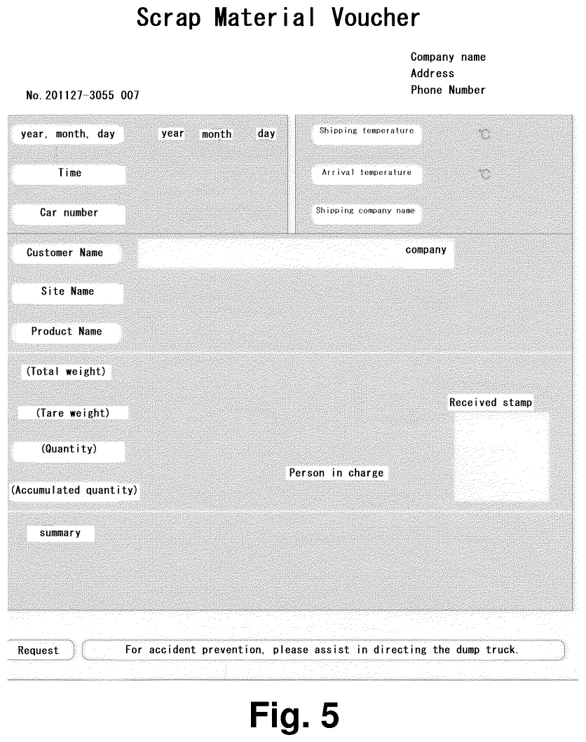

FIG. 4 is a view showing a model sample of the manifest. FIG. 5 is a view showing a model sample of the waste material acceptance form.

According to the present invention, it is possible for a driver transporting industrial waste to complete transfer of required data, authentication, etc. smoothly and promptly without getting out of a vehicle at the time of reception operation for treatment, making it possible to avoid the occurrence of a traffic jam caused by waiting for turns. Furthermore, a manifest for acceptance can be completed by automatically filling a required blank in the manifest using a printer. Compared to the conventional burden of making a necessary entry in handwriting and impressing a stamp, required time can be shortened and mistakes in writing can be reduced.

For example, a recognized item measured using the weighbridge or subjected to AI judgment using a camera may additionally be printed and a stamp may be impressed using a printer on a manifest brought by a driver of a transport vehicle, and then the manifest may be returned to the driver. Furthermore, if an artificial intelligence (AI) judges that writing on the manifest brought by the driver contains errors, a manifest on which the printed error is corrected may be newly printed out and issued.

If an AI is to make judgments based on a video picture in a camera, the type of industrial waste may be estimated or roughly identified by acquiring an entire outer appearance of a load, the volume and color of the load, and the shape of each loaded item (whether a wire is projecting, angulated, or round, for example). In this case, the AI may estimate a weight, etc. by acquiring the shape and volume of the load (the amount of the load) from the video picture in the camera, and double check with data from the weighbridge.

Additionally, the controller may check conformity of a content acquired by the AI at the controller or/and a content acquired using the weighbridge with a content written on the manifest brought by the driver (or a content received through communication from the PDA, for example), and approve its acceptance if the presence of the conformity is determined. To achieve this, the controller may be configured to acquire the type, amount, etc. of industrial waste written in advance on the manifest by scanning the manifest with a scanner and retrieving the manifest as a video picture, then reading letters as written contents using OCR (optical character recognition), for example.

The PDA or the vehicle-mounted unit may be configured in such a manner as to be capable of checking a content, etc. by making conversation with an acceptance office by being provided with a microphone and a speaker. Furthermore, conversation may be made on a smartphone in the office with the inside of a vehicle.

The high-efficiency collection system for industrial waste described in the present embodiment includes: a vehicle-mounted unit mounted on a transport vehicle that collects industrial waste and transports the industrial waste to a treatment site; and a controller provided at an acceptance facility that accepts and treats the industrial waste. The controller acquires a load weight on the transport vehicle measured using a weighbridge, receives industrial waste treatment related information from the vehicle-mounted unit, and performs acceptance operation. The industrial waste treatment related information includes at least the name of a waste generator, a transport trustee, a transport permission number, the type, quantity, shape, and packing type of the industrial waste to be discharged, a driver's name, and a transport date.

As a result, it becomes possible to encourage an increase in speed of measurement using the weighbridge and reception operation relating to the acceptance operation at an acceptance facility for industrial waste. This can shorten time waiting for reception and also reduce the occurrence of a traffic jam. The controller at the facility can perform the reception operation by receiving the industrial waste treatment related information from the vehicle-mounted unit during measurement on the transport vehicle using the weighbridge or immediately before the measurement. This eliminates the need for a driver to get out of the vehicle, enter a facility office, and make an entry or impress a stamp on a manifest, etc. A necessary item can be written and printed out, a database can be complied, and recording and storing can be done automatically by the controller. Specifically, paper-based declaration or check of the industrial waste treatment related information is omitted between the driver and the facility during the reception operation and transfer of data about the industrial waste treatment related information can be completed electronically through radio transmission. Thus, a paperless style can be realized. Additionally, the industrial waste treatment related information includes at least the name of a waste generator, a transport trustee, a transport permission number, the type, quantity, shape, and packing type of the industrial waste to be discharged, a driver's name, and a transport date that are generally essential to the manifest. This is preferable as making a declaration, check, approval, etc. can be completed electronically while they have conventionally been made in a paper-based manner.

Preferably, the high-efficiency collection system for industrial waste described in the present embodiment is characterized in that the controller includes: a camera that acquires a video picture of an outer appearance of the transport vehicle on the basis of the video picture acquired by the camera; and AI that estimates the type and weight of a load on the transport vehicle, conformity between the weight of the load estimated by the AI and the load weight on the transport vehicle measured using the weighbridge is determined, and the load weight is printed on a manifest and the manifest is output if the presence of the conformity is determined.

As a result, it becomes possible for the AI to acquire the situation of the load on the transport vehicle as well as the truck, the type, size specification, and license plate of the transport vehicle, a driver, etc. based on a video picture or an image acquired by the camera. This further allows estimation of the type and amount of the load. Furthermore, an aid to determining approval or disapproval of acceptance by the controller at the facility can be given by distinguishing the driver in terms of affiliation, age, possessed qualifications for operation, the presence of a license, etc. using a facial recognition function of the AI. An aid to determining approval or disapproval of acceptance by the controller can also be given by examining comparison of recognition results about the judgment by the AI with the measured results using the weighbridge, for example, and/or with a declared content electronically transmitted by radio from the vehicle-mounted unit. If the result of the comparison shows that favorable conformity is obtained, the declared content is determined to be trustworthy and approved for acceptance. Then, the result or content of the approval can be printed out on a manifest and the manifest can be output automatically from a printer of the controller.

More preferably, the high-efficiency collection system for industrial waste described in the present embodiment is characterized in that the controller determines conformity of the load type on the transport vehicle estimated by the AI with a load type written on the manifest submitted by the driver and read by a scanner or/and with a load type included in the industrial waste treatment related information received from the vehicle-mounted unit, and prints an approval stamp for the load type on the manifest and outputs the manifest if the presence of the conformity is determined.

As a result, it becomes possible for the controller equipped with the AI to determine the presence or absence of conformity between the load type estimated on the basis of an image or a video picture in the camera and a content of waste written on the manifest or electronically declared by radio from the vehicle-mounted unit. This allows mistakes in writing or false declarations to be detected with a significant degree of accuracy. In such a case, modification or correction can be encouraged while approval for acceptance is left pending. For example, the controller may include notification means for notifying the driver of the necessity to make modification, etc. on a written content such as a declared content. Furthermore, as it is also possible to identify the type or amount of industrial waste to some degree on the basis of the shape of an outer appearance or state of the load, the type of the transport vehicle such as a truck, for example, it is preferable for the AI to store various types of related data input in advance to the AI available for the determination so as to allow the AI to make determination or judgment as accurate as possible.

More preferably, the high-efficiency collection system for industrial waste described in the present embodiment is characterized in that the industrial waste treatment related information further includes a contract No. based on an industrial waste treatment contract document.

As a result, a database can be complied on the facility side by linking the contract number in the industrial waste treatment contract document to the date and time of treatment, treatment amount, treatment substance, type, etc. of the industrial waste brought in. This is preferable for the reason that, even if some inconsistencies or errors are found later, a cause can be determined by tracing back to a party involved in the industrial waste treatment contract document, etc. and making investigations.

More preferably, the high-efficiency collection system for industrial waste described in the present embodiment is characterized in that the shape of the industrial waste included in the industrial waste treatment related information is distinguished at least between solid, muddy, and liquid, and the packing type of the industrial waste included in the industrial waste treatment related information is distinguished at least between loose, in a container, in a drum, or in a bag.

This is preferable as it makes it possible to acquire information for making finer distinction of the shape of the industrial waste between solid, muddy, liquid, etc., and to acquire information for making finer distinction of the packing type of the industrial waste between loose, in a container, in a drum, or in a bag. Operation for making more accurate distinction and preparation for the operation can be performed more easily.

As the AI (artificial intelligence) learns more variations of packing types of loads on transport vehicles or more measured weight values are obtained using weighbridges, the AI makes more accurate estimations. Thus, based on a packing type or a measured weight value obtained using a weighbridge, the AI may judge the likelihood of declared data from the transport vehicle (a value read by OCR from an item written on the submitted manifest or data received from the vehicle-mounted unit through radio transmission). If the judged value is equal to or greater than a predetermined threshold (a reliability of 80%, for example), the declared data may be determined to be reliable and accepted and approved as it is. If the judged value is equal to or less than the predetermined threshold, a loaded item or a load amount may be checked or inspected thoroughly. By accumulating such data, it becomes possible to improve the accuracy of the AI further in response to the accumulation of empirical values.

More preferably, the high-efficiency collection system for industrial waste described in the present embodiment is characterized in that a printer provided to the controller has a print format for a manifest or/and a print format for a waste material acceptance form.

As a result, this printer becomes available as a dedicated printer for printing on a manifest, etc. Preferably, the printer is configured in such a manner as to allow a necessary item to be printed properly in an intended size on an intended place in a manifest or in a form. This can be achieved by preparing a format (template), etc. in advance as preset data, for example.

As already described above, according to the present invention, it is possible to encourage increased speed at a disposal site in performing operation of accepting a transport vehicle with discharged waste and to make reception in a paperless style. Thus, the occurrence of a jam due to waiting vehicles can be avoided. Furthermore, even if there are errors or false statements in a manifest brought by a driver of the transport vehicle, in an item written in advance in a declaration table, or in declared data received in the form of electronic data through communication, it is still possible for the AI to make judgments on its validity promptly and correctly during the reception operation at the disposal site. It is possible to make distinction promptly and correctly between a vehicle that can be approved and passed as it is and a vehicle having an item to be inspected or checked. The AI may be given a packing type in an outer appearance obtained from the camera and additionally, a weight as data measured using the weighbridge, and may make true-false judgments on a content of industrial waste, etc. declared from the driver of the transport vehicle. Then, a more accurate content may be printed on a place for a predetermined item in a manifest or in a form and the manifest or the form may be output. Compared to a conventional reception step implemented between a driver of a waste transport vehicle and a person in charge of reception at a treatment site including handwriting and impressing a stamp based on a paper-based document, transferring the document by hand, mutually checking a content, etc., a speed can be considerably increased and the occurrence of written mistake, error, or correction can be reduced.

The foregoing configurations described in the present embodiment are merely specific examples given for the convenience of description. It is possible to make changes, adaptations, additions, deletions, and corrections as appropriate to structures, base materials, raw materials, steps, methods, configurations, work procedures, etc., within a range not limited to the described content but obvious to a person skilled in the art and within a range covering the technical idea of the present invention.

### Industrial Applicability

The present invention is applicable to a high-efficiency collection system for industrial waste.

Reference Signs List
1000 High-efficiency collection system for industrial waste
1100 Industrial waste treatment facility
1110 Weighbridge
1120 Controller
1130 Camera
1140 Communication interface
1150 Printer
1160 Display monitor
1200 Waste transport vehicle
1210 Vehicle-mounted unit

What is claimed is:

1. A high-efficiency collection system for industrial waste comprising:
a vehicle-mounted unit mounted on a transport vehicle that collects industrial waste and transports the industrial waste to a treatment site; and
a controller provided at an acceptance facility that accepts and treats the industrial waste, the controller acquiring a load weight on the transport vehicle measured using a weighbridge, receiving industrial waste treatment related information from the vehicle-mounted unit, and performing acceptance operation, wherein
the industrial waste treatment related information includes at least the name of a waste generator, a transport trustee, a transport permission number, the type, quantity, shape, and packing type of the industrial waste to be discharged, a driver's name, and a transport date.

2. The high-efficiency collection system for industrial waste according to claim 1, wherein
the controller includes: a camera that acquires a video picture of an outer appearance of the transport vehicle; and AI that estimates the type and weight of a load on the transport vehicle on the basis of the video picture acquired by the camera,
conformity between the weight of the load estimated by the AI and the load weight on the transport vehicle measured using the weighbridge is determined, and the load weight is printed on a manifest and the manifest is output if the presence of the conformity is determined.

3. The high-efficiency collection system for industrial waste according to claim 2, wherein
the controller determines conformity of the load type on the transport vehicle estimated by the AI with a load type written on the manifest submitted by a driver and read by a scanner or/and with a load type included in the industrial waste treatment related information received from the vehicle-mounted unit, and prints an approval stamp for the load type on the manifest and outputs the manifest if the presence of the conformity is determined.

4. The high-efficiency collection system for industrial waste according to claim 2, wherein
a double check is made by comparing the weight estimated by the AI and the weight acquired using the weighbridge.

5. The high-efficiency collection system for industrial waste according to claim 1, wherein
the industrial waste treatment related information further includes a contract No. based on an industrial waste treatment contract document.

6. The high-efficiency collection system for industrial waste according to claim 1, wherein
the shape of the industrial waste included in the industrial waste treatment related information is distinguished at least between solid, muddy, and liquid, and the packing type of the industrial waste included in the industrial waste treatment related information is distinguished at least between loose, in a container, in a drum, or in a bag.

7. The high-efficiency collection system for industrial waste according to claim 1, wherein
a printer provided to the controller has a print format for a manifest or/and a print format for a waste material acceptance form.

8. The high-efficiency collection system for industrial waste according to claim 1, wherein
the controller performs acquisition of a measured value about the load weight on the transport vehicle using the weighbridge and reception of the industrial waste treatment related information from the vehicle-mounted unit simultaneously and in parallel with each other.

9. The high-efficiency collection system for industrial waste according to claim 1, wherein
the vehicle-mounted unit is a PDA (personal digital assistant: personal information terminal) or a smartphone.

10. The high-efficiency collection system for industrial waste according to claim 1, wherein
the vehicle-mounted unit retrieves the industrial waste treatment related information recorded in a USB memory and transmits the industrial waste treatment related information to the controller.

11. The high-efficiency collection system for industrial waste according to claim 2, wherein
if the AI estimates a load type on the basis of a video picture acquired by the camera, the AI estimates the type by grasping an entire outer appearance of the load, the volume and color of the load, and the shape of each loaded item in terms of whether a wire is projecting, angulated, or round.

12. The high-efficiency collection system for industrial waste according to claim 2, wherein
on the basis of the estimation by the AI, if the likelihood of the industrial waste treatment related information received by the controller is equal to or greater than a predetermined threshold, the industrial waste treatment related information is accepted and approved as it is.
